(19) United States
(12) Patent Application Publication
(10) Pub. No.: US 2026/0093013 A1
(43) Pub. Date: Apr. 2, 2026

(54) OPTICAL SCANNER, LASER DETECTION SYSTEM AND AUTONOMOUS VEHICLE

(71) Applicant: HON HAI PRECISION INDUSTRY CO., LTD., New Taipei (TW)

(72) Inventor: YUNG-CHANG TSENG, New Taipei (TW)

(21) Appl. No.: 19/316,165

(22) Filed: Sep. 2, 2025

(30) Foreign Application Priority Data
Sep. 30, 2024 (CN) 202411381032.0

(51) Int. Cl. G01S 7/481; G01S 17/89; G01S 17/931

(52) U.S. Cl. CPC G01S 7/4817; G01S 7/4814; G01S 17/89; G01S 17/931

(57) ABSTRACT

Embodiments of the present disclosure relate to an optical scanner, a laser detection system, and an autonomous vehicle. The optical scanner includes a polarizing beam splitter, a wave plate, and an optical phased array chip. The polarizing beam splitter is configurated to split a source light into a first laser with a first polarization state and a non-working light with a second polarization state, and to reflect the first laser light and transmit the non-working light. The wave plate is configurated to receive the first laser light and emit a second laser with a third polarization state. The first polarization state, the second polarization state and the third polarization state are different from each other. The optical phased array chip is configurated to receive the second laser light and emit a reference light in a variable direction within a scanning angle.

### FIELD

The subject matter herein generally relates to optical scanners, laser detection systems using the optical scanners and autonomous vehicles using the laser detection systems.

### BACKGROUND

Laser detection system has broad application prospects in the field of remote sensing and unmanned driving. One of the key points to achieve laser detection is the design of an optical scanner in a laser emitting device. The optical scanner is used for converting a source light emitted by a laser source into a reference light that is deflected to multiple angles.

Existing optical scanners use micro-electro-mechanical system (MEMS) chips to scan or directly scan with mirrors and motors. The MEMS chip contains multiple rotating micromirrors that are deflected by a rocker arm to enable multi-angle scanning of the laser. However, when the rocker arm or rotating motor vibrates, there is a risk that the internal leads of the optical scanner will break due to resonance, shortening service life of the optical scanner. In addition, the reference light converted by the optical scanner has a divergence angle after passing through the micromirrors or mirrors, resulting in partial loss of light energy, and an effective scanning distance of the reference light is reduced.

Another existing optical scanner uses an ordinary beam splitter to split a source light reflected and transmitted on a surface, so that the incident source light transmitted to the MEMS chip and a reflected light without deflection angle are on the same optical axis. However, since the reflectance and transmittance rates of ordinary beam splitters for unpolarized light are about 50 %, that is, each time light passes through ordinary beam splitters, 50 % of the light energy may be lost. When the ordinary beam splitter transmits the light from the laser source to the MEMS chip, and then emits the reference light through the MEMS chip, it is equivalent to 75 % of the light energy loss caused by the light passing through the ordinary beam splitter twice, which reduces the luminous efficiency of the laser source. In addition, ordinary beam splitters cannot block the interference light from external light sources, which causes noise to the reference light, therefore, the scanning quality of the optical scanner is affected. In order to reduce the influence of low light efficiency on scanning quality, the existing optical scanner needs to additionally add a light collector lens at the light outlet of the reference light to concentrate the light energy. However, such configurations are not conducive to the miniaturization of the optical scanner.

Therefore, there is room for improvement in the art.

### BRIEF DESCRIPTION OF THE DRAWINGS

Implementations of the present disclosure will now be described, by way of embodiment, with reference to the attached figures.

FIG. 1 is a diagram of a laser detection system according to an embodiment of the present disclosure.

FIG. 2 is a diagram showing an optical path of an optical scanner of the laser detection system in FIG. 1.

FIG. 3 is a workflow diagram of the laser detection system in FIG. 1.

FIG. 4 is a diagram showing an embodiment of a reflective layer of an optical phased array chip in the laser detection system in FIG. 1.

FIG. 5 is a diagram showing an embodiment of an arrangement of four laser detection systems in FIG. 1.

FIG. 6 is a diagram of an autonomous vehicle according to an embodiment of the present disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the exemplary embodiments described herein. However, it will be understood by those of ordinary skill in the art that the exemplary embodiments described herein may be practiced without these specific details. In other instances, methods, procedures, and components have not been described in detail so as not to obscure the related relevant feature being described. Also, the description is not to be considered as limiting the scope of the exemplary embodiments described herein. The drawings are not necessarily to scale and the proportions of certain parts may be exaggerated to better illustrate details and features of the present disclosure.

The term “comprising” when utilized, means “including, but not necessarily limited to”; it specifically indicates open-ended inclusion or membership in the so-described combination, group, series, and the like. The disclosure is illustrated by way of example and not by way of limitation in the figures of the accompanying drawings in which like references indicate similar elements. It should be noted that references to “an” or “one” embodiment in this disclosure are not necessarily to the same embodiment, and such references can mean “at least one”.

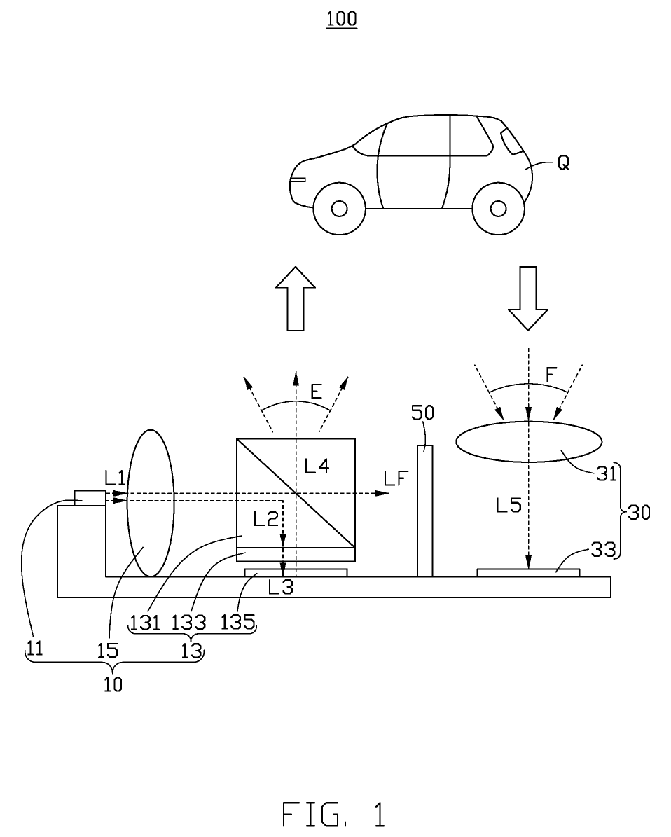

As shown in FIG. 1, a laser detection system 100 includes a laser emitting device 10 and a laser receiving device 30. The laser emitting device 10 includes a laser source 11 and an optical scanner 13. The laser source 11 is used for emitting a source light L1, and the optical scanner 13 is used for converting the source light L1 into a reference light L4 emitted to a target Q to be measured. The laser receiving device 30 is used for receiving a detection light L5 reflected by the target Q when the reference light L4 is projected at the target Q and obtaining a distance information of the target Q according to the detection light L5.

In one embodiment, the laser source 11 includes a light-emitting array composed of at least one laser. For example, the laser source 11 includes a light-emitting array composed of lasers such as semiconductor lasers or distributed feedback lasers that meet the range performance requirements. Accordingly, the source light L1 includes at least the light emitted by at least one laser in the light-emitting array. FIG. 1 shows an optical path transformation of a beam of light emitted by a laser for the sake of optical path clarity. Specifically, a wavelength band of the source light L1 is from 905 nm to 1550 nm.

In one embodiment, the laser emitting device 10 further includes a collimating element 15 between the laser source 11 and the optical scanner 13. The collimating element 15 is on an optical path of the source light L1 and is used for collimating the source light L1.

In one embodiment, the optical scanner 13 includes a polarizing beam splitter 131, a wave plate 133 and an optical phased array chip 135.

The polarizing beam splitter 131 is on the optical path of the source light L1 and on a light output side of the collimating element 15. The polarizing beam splitter 131 is used for splitting the collimated source light L1 into a first laser L2 with a first polarization state and a non-working light LF with a second polarization state, and further reflecting the first laser L2 and transmitting the non-working light LF. The first polarization state is different from the second polarization state.

Specifically, the source light L1 includes the first laser L2. The polarizing beam splitter 131 is on the optical path of the source light L1, that is, on an optical path of the first laser L2. The polarizing beam splitter 131 is used to guide at least part of the first laser L2 to the wave plate 133 by reflection. Specifically, the polarizing beam splitter 131 is used for splitting the source light into an S-polarized light and a P-polarized light, reflecting the S-polarized light and transmitting the P-polarized light.

The polarizing beam splitter 131 is a cube structure formed by coating a multi-layer film structure onto inclined surfaces of two right-angle prisms. The polarizing beam splitter 131 utilizes the property that when light is incident at the Brewster angle, the transmission of P-polarized light is 1, while the transmission of S-polarized light is less than 1. After the source light passes through the multi-layer film at the Brewster angle many times, the polarizing beam splitter 131 allows the complete transmission of P-polarized light, while reflecting the majority (at least 90%) of S-polarized light.

In one embodiment, the first laser L2 is the S-polarized light reflected by the polarizing beam splitter 131, and the non-working light LF is the P-polarized light transmitted by the polarizing beam splitter 131.

In other embodiments, the first laser L2 is the P-polarized light transmitted by the polarizing beam splitter 131, and the non-working light LF is the S-polarized light reflected by the polarizing beam splitter 131.

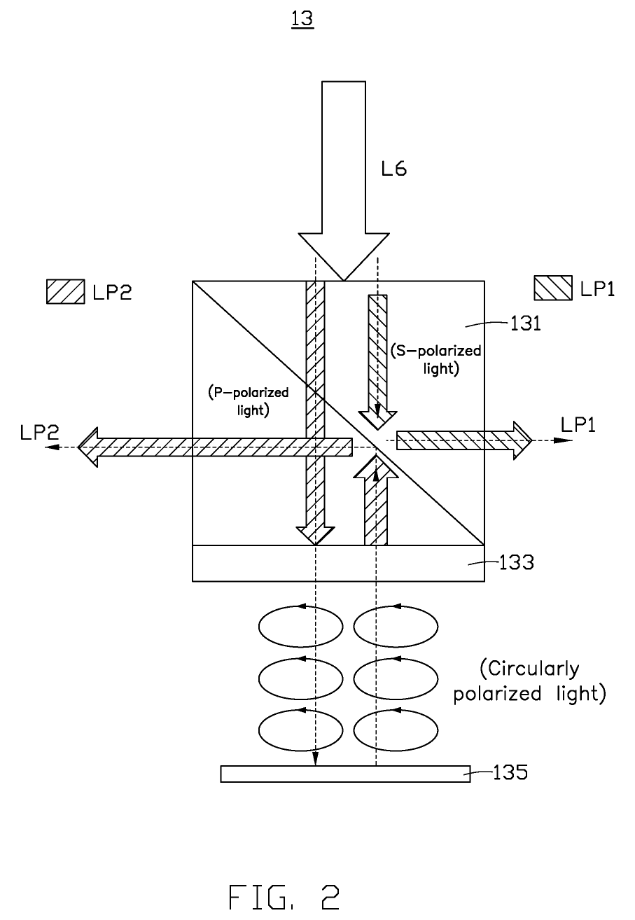

As shown in FIG. 2, the polarizing beam splitter 131 is further used to remove an interference light L6 from an external light source in the laser emitting device 10. The S-polarized light in the interference light L6 is removed along a first optical path LP1, and the P-polarized light in the interference light L6 is removed along a second optical path LP2. In other words, the interference light L6 entering the optical scanner 13 will no longer be emitted in the same direction as the reference light L4, thus preventing noise formation and improving the scanning quality of the optical scanner 13.

As shown in FIG. 1, the wave plate 133 is on a side of the polarizing beam splitter 131 for emitting a reflected light. That is, the wave plate 133 is on the optical path of the first laser L2 reflected by the polarizing beam splitter 131. The wave plate 133 is used for receiving the first laser L2 from the polarizing beam splitter 131 and emitting a second laser L3 with a third polarization state. The third polarization states are different from the first polarization state and the second polarization state.

Specifically, the wave plate 133 is a quarter-wave plate, the first laser L2 is an S-polarized light, the non-working light LF is a P-polarized light, and the second laser L3 converted by the wave plate 133 is a circularly polarized light.

The optical phased array chip 135 is on a side of the wave plate 133 away from the polarizing beam splitter 131, and on the optical path of the second laser L3 emitted from the wave plate 133. The optical phased array chip 135 is used for receiving the second laser L3 from the wave plate 133 and emitting the reference light L4 to the target Q. The optical phased array chip 135 is further used to change the direction of the reference light L4. That is, the optical phased array chip 135 can emit the reference light L4 in a variable direction within a scanning angle E. The reference light L4 passes through the wave plate 133 and the polarizing beam splitter 131 and reaches the target Q. Specifically, the reference light L4 is converted into a P-polarized state through the wave plate 133 and is completely transmitted as P-polarized light after passing through the polarizing beam splitter 131, and is emitted in a direction different from the non-working light LF and the second laser L3, which is equivalent to reducing an optical loss of the source light L1 by the optical scanner 13.

Specifically, the optical phased array chip 135 includes a reflective layer R close to the wave plate 133, and the second laser L3 is converted into the reference light L4 by the reflective layer R.

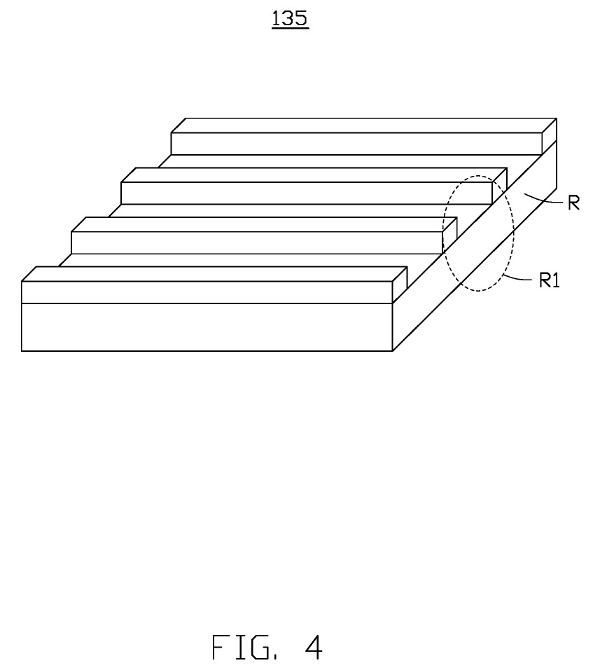

As shown in FIG. 1 and FIG. 4, the reflective layer R includes a plurality of micro-reflective units R1. The micro-reflective units R1 can be, but not limited to, grating structures. The reference light L4 consists of the light emitted by all the micro-reflective units R1. When the second laser L3 reaches the reflective layer R, the second laser L3 refracts and reflects at the micro-reflector units R1 to form a reference light L4. Since the direction of the light emitted by each micro-reflective unit R1 can be different, the reference light L4 emits in multiple directions. In FIG. 1, the second laser L3 and the reference light L4 are shown with arrows.

The wave plate 133 and the polarizing beam splitter 131 are on the optical path of the reference light L4, and the reference light L4 is guided to the target Q after passing through the wave plate 133 and the polarizing beam splitter 131 in turn.

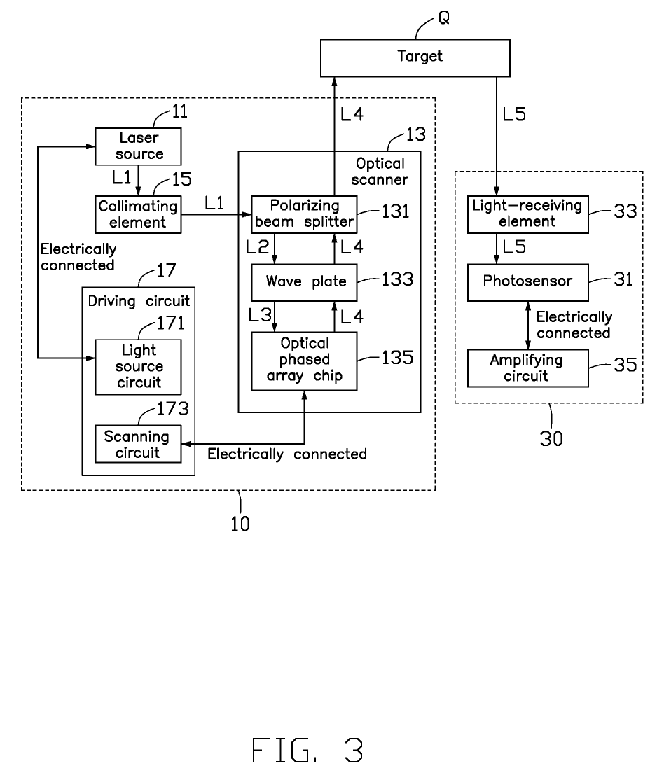

As shown in FIG. 3, the laser emitting device 10 further includes a driving circuit 17. The driving circuit 17 includes a light source circuit 171 and a scanning circuit 173. The light source circuit 171 is electrically connected to the laser source 11 and is used for power supply to drive the laser source 11 to emit the source light L1. The scanning circuit 173 is electrically connected to the optical phased array chip 135 and is used for driving the optical phased array chip 135 to deflect the angle of the reference light L4.

Specifically, the scanning circuit 173 outputs different control voltages for changing physical and optical properties of the reflective layer R, and then changing the direction of light emission at the micro-reflective units R1. For example, when the reflective layer R is a reflective liquid crystal layer, the reflective layer R includes a plurality of liquid crystal molecules arranged in order, and the control voltages control the liquid crystal molecules to deflect, thereby changing a refractive index of the reflective layer R. When the second laser L3 is refracted and reflected at the micro-reflective units R1 to form the reference light L4, the direction of the reference light L4 changes as the refractive index of the reflective layer R.

In one embodiment, the laser receiving device 30 includes a photosensor 31 and a light-receiving element 33. The light-receiving element 33 surrounds the photosensor 31 and is used for converging and guiding the detection light L5 to the photosensor 31. The photosensor 31 is used for obtaining the distance information of the target Q according to the detection light L5. Specifically, the light-receiving element 33 can be, but not limited to, an aspherical lens, a Fresnel lens or a freeform lens.

In one embodiment, the light-receiving element 33 is made of a material with a high refractive index (e.g., 1.8 or more), so that the light-receiving element 33 has a good light-collecting effect on the detection light L5 and is conducive to thinning of the light-collecting element 33.

The laser receiving device 30 further includes an amplifying circuit 35, and the amplifying circuit 35 is used for amplifying an amplitude of an output signal of the photosensor 31 to improve a working precision of the photosensor 31.

As shown in FIG. 1, the laser detection system 100 further includes a laser monitoring device 50 on an optical path of the non-working optical LF. The laser monitoring device 50 is between the laser emitting device 10 and the laser receiving device 30 and is used for monitoring and receiving the non-working optical LF in real time and blocking the non-working optical LF from being transmitted to the laser receiving device 30, so that the work of the photosensor 31 is not disturbed. The laser monitoring device 50 is further used for converting the received non-working optical LF into an electrical signal, and monitoring a frequency range, power range and waveform type of the electrical signal in real time. For example, the laser monitoring device 50 monitors in real time whether the frequency range of the electric signal is between 200 kHz to 1000 kHz, whether the power range of the electric signal is between 50 W to 100 W and whether the waveform type of the electric signal is square wave or chord wave. The laser monitoring device 50 feeds back the collected information in real time to the laser source 11 of the laser emitting device 10 and the photosensor 31 of the laser receiving device 30, so that the laser source 11 and the photosensor 31 adjust the working state accordingly in time.

The laser monitoring device 50 includes a monitoring photodiode (MPD). The MPD can be, but not limited to, an avalanche photodiode (APD) or a single photon avalanche diode (SPAD).

The laser emitting device 10 and the laser receiving device 30 are arranged at intervals or close to each other, so that the laser detection system 100 can use time-of-flight (TOF) ranging method, amplitude modulated continuous wave (AMCW) ranging method, frequency modulated continuous wave (FMCW) ranging method or other methods calculate and obtain the distance information of the target Q by comparing the reference light L4 and the detection light L5.

In one embodiment, the scanning angle E of the reference light L4 emitted by the laser emitting device 10 includes an angular range of 30° to 60° in the horizontal direction and an angular range of 20° to 30° in the vertical direction. The range of a receiving angle F of the laser receiving device 30 is the same as the range of the scanning angle E of the single laser emitting device 10. Thus, the laser detection system 100 can detect the distance information of the target Q in a field of view of at least 30° to 60° in the horizontal direction and 20° to 30° in the vertical direction. In addition, the laser detection system 100 can further realize the distance information of the target Q within the distance range of 100 meters to 200 meters.

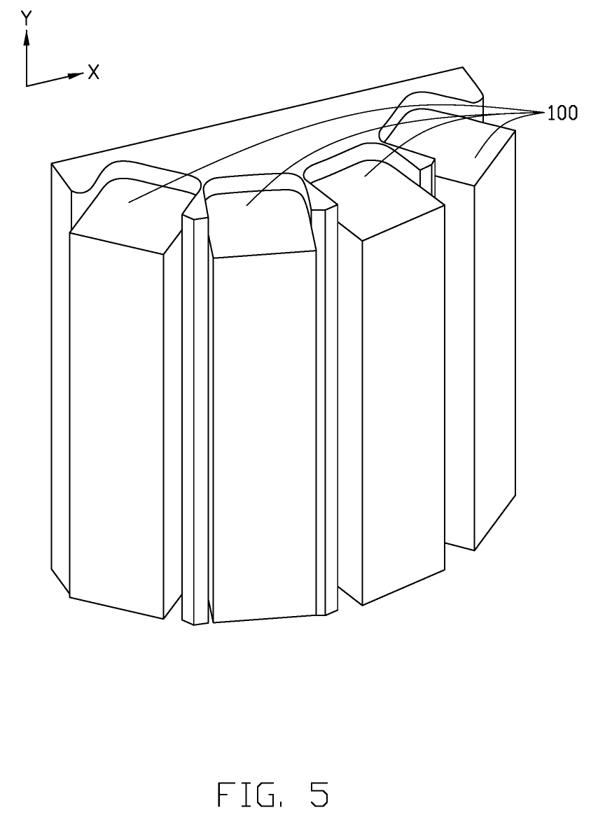

Further, a plurality of laser detection systems 100 can be used in combination, and arranged in the horizontal direction and/or in the vertical direction in a manner such as 1×2, 1×3, 1×4, so as to increase the overall scanning angle E and light receiving angle F and detect the target Q in a wide field of view. As shown in FIG. 5, four laser detection systems 100 are arranged in a row in the horizontal direction X and in four columns in the vertical direction Y along an arc, which can realize the distance information of the target Q in the angle range of 120° to 240° in the horizontal direction X.

In order to improve the light efficiency, the surfaces of the optical elements through which the light pass through in the laser detection system 100 is coated with an anti-reflective film corresponding to the wavelength range of the source light L1, such as the collimating element 15, the polarizing beam splitter 131, the wave plate 133 and the light-receiving element 33.

In the laser detection system 100, the optical scanner 13 uses the polarizing beam splitter 131 and the wave plate 133 to convert the outgoing reference light L4 into a penetrable polarity, which is beneficial to reduce the optical loss, remove the interference light L6 from the external light source in the direction of the reference light L4, and improve the scanning quality. The optical phased array chip 135 is further used to replace the existing MEMS chip, and the all-solid-state structure characteristics and physical optical properties of the optical phased array chip 135 are fully combined, so that the reference light L4 with highly concentrated light energy and multi-angle deflection can be generated, the effect of high-efficiency light collection and large field of view scanning is achieved, and the scanning performance and service life of the optical scanner 13 are improved. In addition, there is no need for an additional condenser lens, which is beneficial to the miniaturization of the laser detection system 100.

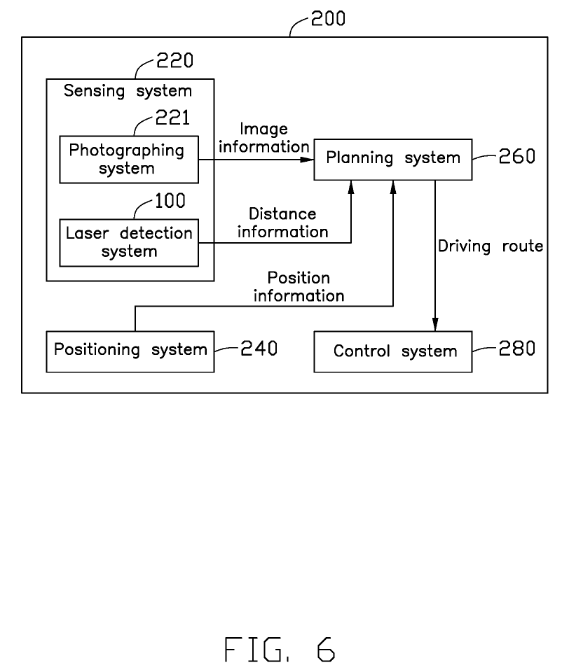

As shown in FIG. 6, an autonomous vehicle 200 includes a sensing system 220, a positioning system 240, a planning system 260 and a control system 280. The sensing system 220 includes a photographing system 221 and the laser detection system 100. The photographing system 221 is used for obtaining an image information of the target Q, and the laser detection system 100 is used for obtaining the distance information of the target Q. The positioning system 240 is used for obtaining the position information of the autonomous vehicle 200 by connecting a satellite navigation system. The planning system 260 is used for planning a driving route of the autonomous vehicle 200 according to the information provided by the sensing system 220 and the positioning system 240. The control system 280 is used for adjusting the speed and steering angle of the autonomous vehicle 200 in real time according to the driving route provided by the planning system 260.

In one embodiment, the photographing system 221 includes at least a plurality of cameras or other sensors that meet functional requirements. The photographing system 221 can work in conjunction with the laser detection system 100. Once the target Q is identified, the image information and distance information of the target Q can be synchronously or sequentially obtained, and the image information and the distance information can be combined with each other.

The sensing system 220 in the autonomous vehicle 200 matches the camera system 221 with the laser detection system 100 to acquire the image information and the distance information of the target Q which makes full use of the advantages of high efficiency, long service life and high performance of the laser detection system 100 and is beneficial to improving the accuracy of the sensing system 220 in acquiring the information of the target Q. The planning system 260 is conducive to accurately and reasonably planning the driving route of the autonomous vehicle 200 according to the information provided by the sensing system 220 and the positioning system 240, so that the control system 280 can adjust the speed and steering angle of the autonomous vehicle 200 in real time, so as to bypass or reach the target Q.

It is to be understood, even though information and advantages of the present exemplary embodiments have been set forth in the foregoing description, together with details of the structures and functions of the present exemplary embodiments, the disclosure is illustrative only. Changes may be made in detail, especially in matters of shape, size, and arrangement of parts within the principles of the present exemplary embodiments to the full extent indicated by the plain meaning of the terms in which the appended claims are expressed.

What is claimed is:

1. An optical scanner comprising:
a polarizing beam splitter configurated to split a source light into a first laser with a first polarization state and a non-working light with a second polarization state, and to reflect the first laser light and transmit the non-working light;
a wave plate configurated to receive the first laser light and emit a second laser with a third polarization state, wherein the first polarization state, the second polarization state and the third polarization state are different from each other; and
an optical phased array chip configurated to receive the second laser light and emit a reference light in a variable direction within a scanning angle.

2. The optical scanner of claim 1, wherein the optical phased array chip comprises a reflective layer configured for converting the second laser into the reference light, and the reference light is emitted from the optical scanner after passing through the wave plate and the polarizing beam splitter.

3. The optical scanner of claim 2, wherein the reference light has the second polarization state after passing through the wave plate, the reference light is transmitted by the polarizing beam splitter and emitted from the optical scanner in a direction different from the non-working light and the second laser light.

4. The optical scanner of claim 1, wherein the first polarization state is an S polarization state, the second polarization state is a P polarization state, the wave plate is a quarter wave plate, and the third polarization state is a circular polarization state.

5. A laser detection system comprising:
a laser emitting device comprising a laser source configurated to emit a source light and an optical scanner comprising:
a polarizing beam splitter configurated to split the source light into a first laser with a first polarization state and a non-working light with a second polarization state, and to reflect the first laser light and transmit the non-working light;
a wave plate configurated to receive the first laser light and emit a second laser with a third polarization state, wherein the first polarization state, the second polarization state and the third polarization state are different from each other; and
an optical phased array chip configurated to receive the second laser light and emit a reference light in a variable direction within a scanning angle to a target; and
a laser receiving device configurated to receive a detection light reflected by the target when the reference light is projected at the target, and to obtain a distance information of the target according to the detection light.

6. The laser detection system of claim 5, wherein the optical phased array chip comprises a reflective layer configured for converting the second laser into the reference light, and the reference light is emitted from the optical scanner after passing through the wave plate and the polarizing beam splitter.

7. The laser detection system of claim 6, wherein the reference light has the second polarization state after passing through the wave plate, the reference light is transmitted by the polarizing beam splitter and emitted from the optical scanner in a direction different from the non-working light and the second laser light.

8. The laser detection system of claim 5, wherein the first polarization state is an S polarization state, the second polarization state is a P polarization state, the wave plate is a quarter wave plate, and the third polarization state is a circular polarization state.

9. The laser detection system of claim 5, wherein the laser source is a semiconductor laser or a distributed feedback laser.

10. The laser detection system of claim 5, wherein a wavelength band of the source light is from 905 nm to 1550 nm.

11. The laser detection system of claim 5, wherein the laser emitting device further comprises a light source circuit and a scanning circuit, the light source circuit is electrically connected to the laser source, and configurated to drive the laser source to emit the source light, the scanning circuit is electrically connected to the optical phased array chip, and configurated to drive the optical phased array chip to deflect the angle of the reference light.

12. The laser detection system of claim 5, wherein the laser receiving device comprises a photosensor and a light-receiving element, the light-receiving element is configurated to converge and guide the detection light to the photosensor, and the photosensor is configurated to obtain a position information of the target according to the detection light.

13. An autonomous vehicle comprising:
a laser detection system comprising:
a laser emitting device comprising a laser source configurated to emit a source light and an optical scanner comprising:
a polarizing beam splitter configurated to split the source light into a first laser with a first polarization state and a non-working light with a second polarization state, and to reflect the first laser light and transmit the non-working light;
a wave plate configurated to receive the first laser light and emit a second laser with a third polarization state, wherein the first polarization state, the second polarization state and the third polarization state are different from each other; and
an optical phased array chip configurated to receive the second laser light and emit a reference light in a variable direction within a scanning angle to a target; and
a laser receiving device configurated to receive a detection light reflected by the target when the reference light is projected at the target, and to obtain the distance information of the target according to the detection light; and
a photographing system configurated to obtain an image information of the target.

14. The autonomous vehicle of claim 13, wherein the optical phased array chip comprises a reflective layer configured for converting the second laser into the reference light, and the reference light is emitted from the optical scanner after passing through the wave plate and the polarizing beam splitter.

15. The autonomous vehicle of claim 14, wherein the reference light has the second polarization state after passing through the wave plate, the reference light is transmitted by the polarizing beam splitter and emitted from the optical scanner in a direction different from the non-working light and the second laser light.

16. The autonomous vehicle of claim 13, wherein the first polarization state is an S polarization state, the second polarization state is a P polarization state, the wave plate is a quarter wave plate, and the third polarization state is a circular polarization state.

17. The autonomous vehicle of claim 13, wherein the laser source is a semiconductor laser or a distributed feedback laser.

18. The autonomous vehicle of claim 13, wherein a wavelength band of the source light is from 905 nm to 1550 nm.

19. The autonomous vehicle of claim 13, wherein the laser emitting device further comprises a light source circuit and a scanning circuit, the light source circuit is electrically connected to the laser source, and configurated to drive the laser source to emit the source light, the scanning circuit is electrically connected to the optical phased array chip, and configurated to drive the optical phased array chip to deflect the angle of the reference light.

20. The autonomous vehicle of claim 13, wherein the laser receiving device comprises a photosensor and a light-receiving element, the light-receiving element is configurated to converge and guide the detection light to the photosensor, and the photosensor is configurated to obtain a position information of the target according to the detection light.
